(19) United States
(12) Patent Application Publication
(10) Pub. No.: US 2014/0003032 A1
(43) Pub. Date: Jan. 2, 2014

(54) STRENGTH-REINFORCED DUAL DISPLAY MODULE

(71) Applicant: Samsung Electronics Co., Ltd., Gyeonggi-do (KR)

(72) Inventor: Sangwon YUN, Gyeonggi-do (KR)

(21) Appl. No.: 13/905,517

(22) Filed: May 30, 2013

(30) Foreign Application Priority Data
Jun. 28, 2012 (KR) 10-2012-0070064

(51) Int. Cl. F21V 15/00

(52) U.S. Cl. CPC F21V 15/00
USPC 362/97.1

(57) ABSTRACT

A display module used for a mobile terminal and particularly, a strength-reinforced dual display module having reinforced strength by adding a transparent sheet to an open area existing at a display module is provided. The dual display module includes: a dual display module frame for mounting two or more display screens, a backlight for illuminating the two or more display screens; and a support sheet between the backlight and one of the two or more display screens.

### CLAIM OF PRIORITY

This application claims the benefit under 35 U.S.C. §119(a) from a Korean patent application filed on Jun. 28, 2012 in the Korean Intellectual Property Office and assigned Serial No. 10-2012-0070064, the entire disclosure of which is hereby incorporated by reference in its entirety.

### BACKGROUND

1. Field of the Invention

The present disclosure relates to a display module used for a mobile terminal, and more particularly, to a strength-reinforced dual display module having reinforced strength by adding a transparent sheet to an open area existing at a display module.

2. Description of the Related Art

In general, mobile terminals provide information to a user through a display device. A liquid crystal display (LCD) is one of type of typical display devices used for a mobile terminal. The LCD has a backlight and displays information to a display device using light emitting from the backlight. Nowadays, as a display device, instead of using only one LCD, two or more LCDs such as a main LCD and a sub-LCD may be formed and incorporated in one module, and the module is mounted in a mobile terminal.

FIG. 1 is a cross-sectional view illustrating a conventional dual display module.

Referring to FIG. 1A, when two or more LCDs 10 and 12 are used for one display device, in order to lower a component cost and to reduce a thickness of a display module, it is common to share a backlight 6 instead of using a separate backlight 6 for each LCD. Further, in order to dispose one backlight 6 between two LCDs 10 and 12 and to share the backlight 6, an open area 2 exists at a dual display module frame 16 between the two LCDs 10 and 12. A characteristic of a general dual display module is to transfer a light source of the backlight 6 to a sub-LCD 10 through the open area 2.

Referring to FIG. 1B, light 8 of the sharing backlight 6 is transferred to the sub-LCD 10 through the open area 2.

Referring to FIG. 1C, when an impact is applied from the outside, a dual display module frame 16 is easily bent due to the absence of support due to open area 2 and thus a problem that the external impact and force is directly transferred to internal elements exists.

That is, in a conventional dual display module, in order to transfer light 8 of the sharing backlight 6, the open area 2 is provided, and thus a problem that the dual display module frame 16 lacks structural support and integrity and is thus easily bent or a scratch occurs at internal constituent elements by an impact applied from the outside of a mobile terminal. Therefore, a problem that a damage range of an internal prism sheet, reflection sheet, and light guide plate at a periphery of the backlight is wide, and the LCD can show a white line or a white point where damage has occurred due to the bending of the LCD.

### SUMMARY

An exemplary aspect of the present invention is to address at least some of the above-described problems and/or disadvantages and to provide at least the advantages described below. Accordingly, an exemplary aspect of the present invention has been made in view of the above problems, and provides a strength-reinforced dual display module that is not easily bent or damaged by an external impact by disposing a transparent sheet at an open area of a dual display module.

In accordance with an aspect of the present invention, a strength-reinforced dual display module used for a terminal includes: a dual display module frame for mounting two or more screens and sharing a backlight; and a transparent sheet for transmitting light of the backlight.

Preferably, the dual display module frame includes an open area, and the transparent sheet is disposed at the open area.

Other exemplary aspects, advantages and salient features of certain exemplary embodiments of the STRENGTH-REINFORCED DUAL DISPLAY MODULE according to the invention will become apparent to a person of ordinary skill in the art from the following detailed description, which, taken in conjunction with the annexed drawings, discloses exemplary embodiments of the invention.

### BRIEF DESCRIPTION OF THE DRAWINGS

The objects, features and advantages of the present invention will be more apparent from the following detailed description in conjunction with the accompanying drawings, in which:

FIG. 1[a-c] is a cross-sectional view illustrating a conventional dual display module according to the prior art;

FIG. 2 is a perspective view illustrating a dual display module according to an exemplary embodiment of the present invention;

FIGS. 3 and 4 are trihedral views illustrating the exemplary dual display module of FIG. 2;

FIGS. 5 and 6 are cross-sectional views illustrating the exemplary dual display module in relation to FIG. 4; and

FIG. 7 is a cross-sectional view illustrating the exemplary dual display module in relation to FIG. 6.

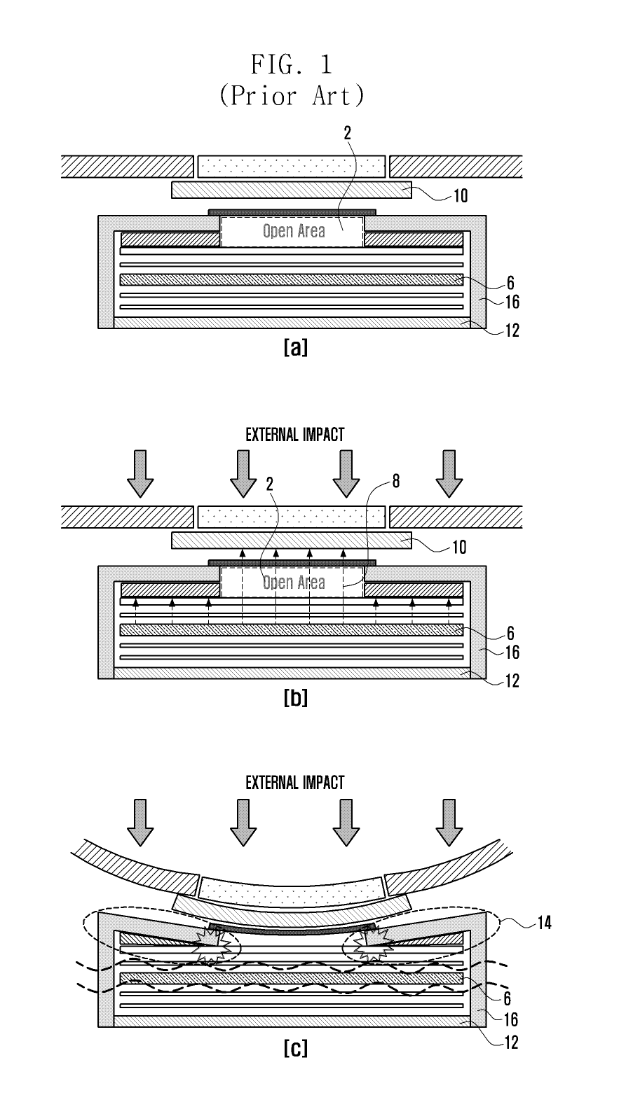

### DETAILED DESCRIPTION

Hereinafter, exemplary embodiments of the present invention are described in detail with reference to the accompanying drawings. The same reference numbers are used throughout the drawings to refer to the same or like parts. The views in the drawings are schematic views only, and are not intended to be to scale or correctly proportioned. In the following description, well-known functions or constructions may not be described in detail when they would obscure appreciation of the present invention by a person of ordinary skill in the art with unnecessary detail of the well-known functions and structures. Also, the terms used herein are defined according to the functions of the present invention as would be understood by a person of ordinary skill in the art. Thus, the terms may vary depending on user's or operator's intension and usage. That is, the terms used herein must be understood based on the descriptions made herein in view of the ordinary level of skill in the art.

In an exemplary embodiment of the present invention, for a better understanding, an example of using an LCD as a display device and using a dual display module having a main LCD and a sub-LCD in a mobile terminal is described. Further, a shape of constituent elements including a dual display module, display frame, main LCD, and sub-LCD used in an exemplary embodiment of the present invention is an example and the present invention is not limited to the particular shape shown and described. That is, a technical characteristic of a strength-reinforced dual display module of the present invention is not limited only to a case of using an LCD as a display device and can be applied to any device having display modules using two or more screens.

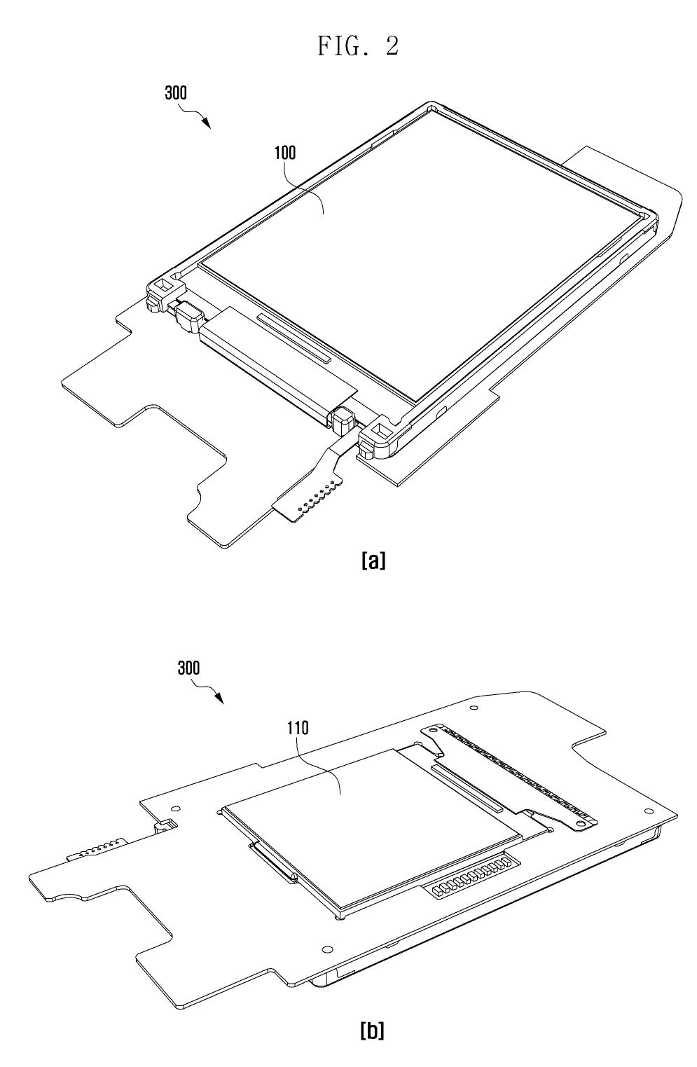

Turning now to FIG. 2 there is shown a perspective view illustrating a dual display module according to an exemplary embodiment of the present invention.

A dual display module 300 is a display device for providing and using two LCDs in one module instead of using one LCD as a display device. When two LCDs are used, a relatively large LCD is referred to as a main LCD 100 and a comparatively smaller LCD is referred to as a sub-LCD 110. The sub-LCD 110 is generally installed for a user to view information on the outside of a mobile terminal.

FIG. 2A illustrates the dual display module 300, depicting the main LCD 100 side which may be used for generally displaying more detailed information and providing a larger area for displaying a greater amount of information on the mobile terminal. FIG. 2B illustrates the dual display module 300 depicting the sub-LCD 110 side, having a comparatively smaller area which may be used for displaying time or other simple information.

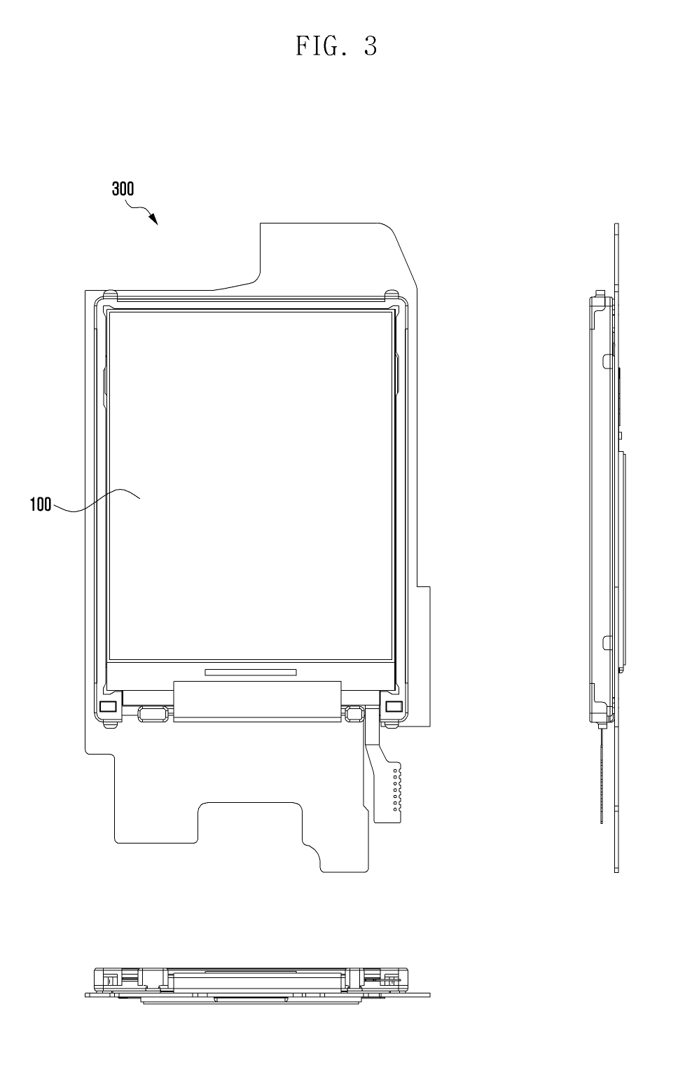

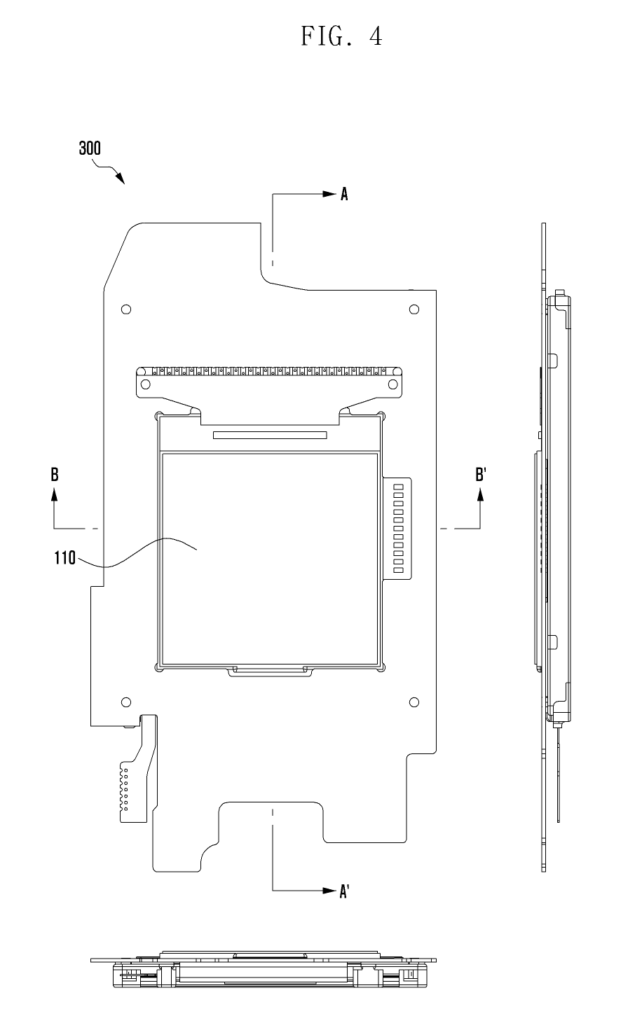

FIGS. 3 and 4 are trihedral views illustrating the dual display module 300 of FIG. 2. FIG. 3 illustrates a front view, right side view, and plan view of the main LCD 100 side in the dual display module 300. FIG. 4 illustrates a front view, right side view, and plan view of the sub-LCD 110 side in the dual display module 300.

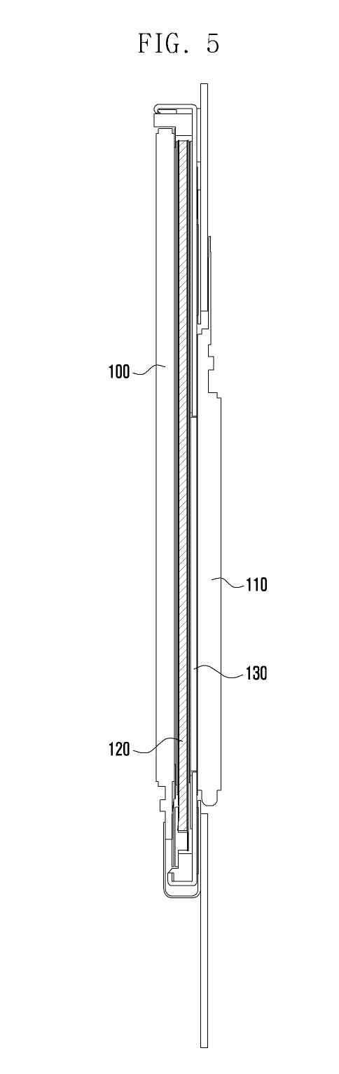

FIG. 5 is a cross-sectional view illustrating the dual display module in relation to FIG. 4 and illustrates the dual display module taken along the cross section line A-A′ of FIG. 4.

Referring to FIG. 5, an open area 130 exists between the sub-LCD 110 and the main LCD 100. The open area 130 exists for disposing and sharing one backlight 120 between the sub-LCD 110 and the main LCD 100. The light of the backlight 120 is propagated and transferred to the sub-LCD 110 through the open area 130.

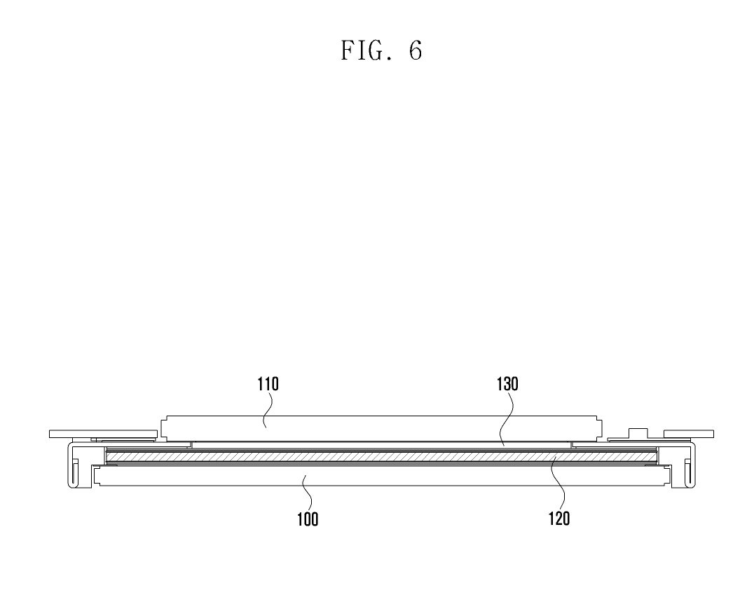

FIG. 6 is a cross-sectional view illustrating the dual display module in relation to FIG. 4 and illustrates the dual display module taken along the cross section line B-B′ of FIG. 4.

Referring to FIG. 6, the open area 130 exists between the sub-LCD 110 and the main LCD 100, and the open area 130 is positioned between the sub-LCD 110 and the main LCD 100 to allow the passage of light from the shared backlight 120 to both the main LCD 100 and the sub-LCD 110.

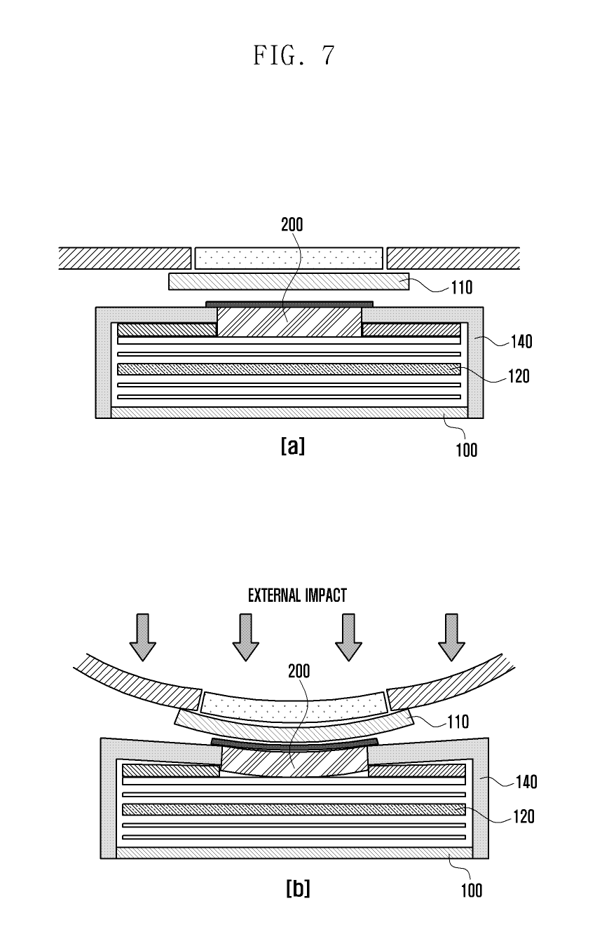

FIG. 7 is a cross-sectional view illustrating the dual display module in relation to FIG. 6. For a better understanding, FIG. 7 illustrates a structure and a cross section of a dual display module by simplifying and enlarging a cross-sectional view which is depicted in FIG. 6.

Referring to FIG. 7A, the present invention is characterized by filling an open area between a main LCD 100 and a sub-LCD 110 by disposing a transparent sheet 200 within an open area typically existing within a conventional dual display module frame 140. By filling the open area with the transparent sheet 200, additional structural support is provided and thus internal elements of the dual display module can be prevented from moving.

Referring to FIG. 7B, there is shown a cross-sectional view of the dual display module of FIG. 7A wherein an impact force is applied from the outside of sub-LCD 110. As shown, the transparent sheet 200 applied to the open area mitigates an impact applied to internal elements and an LCD by distributing the force of the external impact. The transparent sheet 200 provides additional structural support and therefore reduces a bending angle of the dual display module frame 140 in a Z-axis direction. Therefore, the transparent sheet 200 prevents the dual display module frame 140 from being easily bent or scratches from occurring on the internal elements due to an impact applied from the outside. Further, the transparent sheet 200 prevents damage of an internal prism sheet, reflection sheet, and light guide plate at a periphery of the backlight and further prevents the LCD from bending or flexing a white point and white line from occurring at the LCD which may be caused by excessive bending of the LCD components.

A shape, size, thickness and other dimensional parameters of the transparent sheet 200 used for the present invention may be changed according to a shape and a size of an open area existing at the dual display module frame 140. The transparent sheet 200 may be constructed using a material having good transparency such as polycarbonate (PC) or PET but is not limited thereto. One skilled in the art will recognize that other similar engineering plastics may also be suitable for use within the scope of the present invention. Engineering plastics particularly PC, have large impact strength, high heat resistance and a good low temperature characteristic and is stable to light. Polycarbonate is naturally transparent, with the ability to transmit light nearly that of glass. It has high strength, toughness, heat resistance, and excellent dimensional and color stability. PC also has an excellent DI-electric characteristic, and weather resistance. Due to such characteristics, PC materials are widely used for electric and mechanical components.

In this way, by removing the open area by disposing the transparent sheet 200 of a material having good transparency and light transmittance properties and high impact resistance within the open area, the backlight 120 can be shared by both the main LCD 100 and the sub-LCD 110, and the strength of the dual display module 300 can be reinforced.

As described above, according to the an exemplary embodiment of the present invention, by reinforcing strength of a dual display module using a transparent sheet that transmits light, while maintaining an existing effect of sharing a backlight of a main screen and a sub-screen, strength of the dual display module can be additionally reinforced.

Although the invention has been shown and described with reference to certain exemplary embodiments thereof, it will be understood by those skilled in the art that various changes in form and details may be made therein without departing from the spirit and scope of the invention as defined by the appended claims and their equivalents. Therefore, the scope of the present invention should not be limited to the above-described embodiments but should be determined by not only the appended claims but also the equivalents thereof.

### DESCRIPTION OF REFERENCE NUMERALS

100: main LCD
110: sub-LCD
120: backlight
130: open area
140: dual display module frame
200: transparent sheet

What is claimed is:

1. A strength-reinforced dual display module used for a mobile terminal, the strength-reinforced dual display module comprising:
a dual display module frame for mounting two or more display screens, a backlight for illuminating the two or more display screens; and
a support sheet between the backlight and one of the two or more display screens.

2. The strength-reinforced dual display module according to claim 1, wherein the dual display module comprises a main screen and a sub-screen.

3. The strength-reinforced dual display module according to claim 1, wherein the backlight is positioned between the main screen and the sub-screen to emit light to both the main screen and the sub-screen.

4. The strength-reinforced dual display module according to claim 1, wherein the support sheet is mounted within an open area in the dual display module between the backlight and one of the two or more display screens.

5. The strength-reinforced dual display module according to claim 1, wherein the support sheet comprises a transparent light transmissive material.

6. The strength-reinforced dual display module according to claim 1, wherein the support sheet comprises an impact resistant material.

7. The strength-reinforced dual display module according to claim 1, wherein the transparent sheet comprises a transparent polycarbonate (PC) or PET material.

8. The strength-reinforced dual display module according to claim 1, wherein the support sheet comprises an material for distributing an impact force.

9. The strength-reinforced dual display module according to claim 1, wherein the main screen has a larger area that the sub-screen.

10. The strength-reinforced dual display module according to claim 1, wherein the main screen and the sub-screen are positioned to face in opposite directions on the dual display module frame.

11. The strength-reinforced dual display module according to claim 1, wherein the support sheet resists an impact force to reduce bending of the dual display module frame.

12. The strength-reinforced dual display module according to claim 1, wherein the support sheet prevents the internal elements of the dual display module from moving.

13. The strength-reinforced dual display module according to claim 1, wherein the support sheet covers the internal elements of the dual display module.

14. The strength-reinforced dual display module according to claim 1, wherein the internal elements include the internal prism sheet,

15. The strength-reinforced dual display module according to claim 1, wherein the internal elements include the reflection sheet.

16. The strength-reinforced dual display module according to claim 1, wherein the internal elements include the light guide plate.

17. The strength-reinforced dual display module according to claim 1, wherein the support sheet transmits light from the backlight to one of the two or more display screens.

18. The strength-reinforced dual display module according to claim 1, wherein the support sheet distributes an impact force across the dual display module frame.

19. The strength-reinforced dual display module according to claim 1, wherein the support sheet is adjacent to one of the two or more display screens.

20. The strength-reinforced dual display module according to claim 4, wherein the open area is adapted to receive the support sheet.
